(19) United States
(12) Patent Application Publication
(10) Pub. No.: US 2025/0378467 A1
(43) Pub. Date: Dec. 11, 2025

(54) INTEGRATED DIGITAL MARKETING AND PERFORMANCE ANALYSIS PLATFORM

(71) Applicant: John Bennett, Marquette, MI (US)

(72) Inventor: John Bennett, Marquette, MI (US)

(21) Appl. No.: 19/226,824

(22) Filed: Jun. 3, 2025

Related U.S. Application Data
(60) Provisional application No. 63/658,630, filed on Jun. 11, 2024.

(51) Int. Cl. G06Q 30/0241; G06Q 30/0204; G06Q 30/0242

(52) U.S. Cl. CPC G06Q 30/0247; G06Q 30/0204; G06Q 30/0244; G06Q 30/0249

(57) ABSTRACT

A system for digital marketing analysis and management is provided. The system includes a processor and a memory in communication with the processor. The memory includes a user interface module to receive a campaign parameter and learning feedback from the user, an education module to provide instructional content based on the campaign parameter, a campaign module to generate a campaign based on the campaign parameter, an analytics module to analyze the campaign based on an advertisement metric to produce a campaign analysis and generates a real-time performance report, an artificial intelligence (AI) module to generate an analytics forecast, and a reporting module to provide the user with the real-time performance report and analytics forecast. The campaign module adjusts the campaign based on the real-time performance report and directs the user to view the instructional content and provide another learning feedback when the campaign requires an understanding of the user.

### CROSS-REFERENCE TO RELATED APPLICATIONS

This application claims the benefit of U.S. Provisional Application No. 63/658,630, filed on Jun. 11, 2024. The entire disclosure of the above application is incorporated herein by reference.

### FIELD

The present technology relates to digital marketing campaigns, including ways to integrate marketing campaign management with real-time analytics and performance adjustments.

### INTRODUCTION

This section provides background information related to the present disclosure which is not necessarily prior art.

The evolving landscape of digital marketing may present challenges for businesses aiming to maximize return on investment (ROI) through optimized marketing strategies. Marketing systems may necessitate manual adjustments to campaigns in response to changing market conditions and consumer behavior. These manual adjustments may be time-consuming and prone to errors when relying on human judgment and may be unadaptable to real-time market fluctuations. Digital marketing platforms may exhibit limited integration between informative resources available to marketers and the practical execution of marketing campaigns, posing difficulties for marketers new to the field or those operating in dynamic industries.

Marketers may face the challenge of applying theoretical marketing knowledge to practical scenarios immediately and effectively, creating a fragmented experience where marketing decisions may not include real-time data integration or solid educational frameworks, forcing marketers to rely on scattered resources. This gap in knowledge may result in a campaign performance that is less than optimal and may contribute to a difficult learning curve for marketing professionals. Entrepreneurs, business owners, and investors may not possess the theoretical or educational content that accurately correlates a marketing campaign's outcomes with financial projections. Without adequate educational resources, new marketers may resort to speculative approaches, particularly during early business stages, resulting in investments that are more akin to a gamble than a calculated strategy. New marketers may feel as though they are “sold” on package solutions without clear, informed insights into their practical effectiveness. This disconnect between education and campaign performance may be pronounced where marketing efforts and proforma projections are not bundled in a single interface, leading to guesswork and speculative planning rather than precise, data-driven strategies.

Vendors or third-party marketers equipped to analyze and adjust campaigns may be inaccessible to small start-ups, as financial and operational barriers render such services inadequate for businesses with limited resources. Due to these constraints, start-ups may be unable to adopt marketing solutions that link campaign metrics directly with financial projections within a single cohesive platform. Marketers may consequently be obliged to analyze disparate campaign analytics manually and make adjustments without real-time insight, leading to missed opportunities and ineffective marketing expenditures.

Certain marketing systems may not provide actionable analytics that can directly influence campaign decision-making. Other marketing systems may only offer analytical insights in formats that require further interpretation or analysis prior to application, delaying decision-making processes. These delays may result in lost opportunities and ineffective allocation of marketing budgets. Other analytics tools may require separate applications for data analysis and campaign adjustments, creating a fragmented approach that complicates campaign execution and monitoring overall strategy effectiveness across various channels.

Accordingly, there is a need for a digital marketing platform that automates integration of educational content with real-time campaign execution and adjustment, providing actionable insights directly from performance analytics, and facilitates a unified approach to managing and optimizing marketing campaigns across various channels. Desirably, such a platform should eliminate the need for manual analysis and adjustments by replacing guesswork with data-driven decision-making that can directly tie a marketing campaign to a financial projection.

### SUMMARY

In concordance with the instant disclosure, an integrated digital marketing platform that automates an integration of educational content with real-time campaign execution and adjustments, providing actionable insights directly from performance analytics, and facilitates a unified approach to managing and optimizing marketing campaigns across various channels, has surprisingly been discovered.

The present technology includes systems and methods that relate to a digital marketing analysis and management platform that integrates educational content and real-time analytics to facilitate the optimization of marketing strategies and campaign execution. The present technology improves the digital marketing landscape by providing a user with step-by-step theoretical and practical knowledge for building and executing a marketing campaign, and comprehensive analytics of the campaign to allow for campaign adjustments in real-time. The system may enable users including entrepreneurs and marketers, to apply theoretical knowledge with immediate effect, reducing the steep learning curve associated with digital marketing. By providing real-time actionable insights and an educational component tailored to a campaign parameter provided by the user, the system may minimize manual adjustments and errors, allowing for more precise, data-driven decision-making. The system may link marketing efforts directly to the financial gains of the user, offering the user a clear understanding of the impact of marketing campaigns on business objectives. This technological advancement may militate against the need for fragmented tools across different platforms, offering a unified, efficient solution for optimizing return on investment.

In certain embodiments, a system for digital marketing analysis and management for a user is provided. The system may include a processor and a memory in communication with the processor. The memory may include a user interface module, an education module, a campaign module, and an analytics module. The user interface module may receive a campaign parameter and learning feedback from the user. The education module may provide an instructional content to the user based on the campaign parameter and may adjust the instructional content based on the learning feedback. The campaign module may receive the campaign parameter from the user interface module and may generate a campaign for the user based on the campaign parameter. The analytics module may analyze the campaign based on an advertisement metric to produce a campaign analysis and may generate a real-time performance report based on the campaign analysis of the campaign. The campaign module may also receive the real-time performance report from the analytics module, may adjust the campaign when the real-time performance report includes a determination for adjustment, and may direct the user to view the instructional content and provide another learning feedback when the real-time performance report includes a determination that adjusting the campaign requires an understanding of the user.

In certain embodiments, a method for digital marketing analysis and management for a user is provided. The method may operate in conjunction with a system for digital marketing analysis and campaign management for a user, as described herein. The method may include a step of receiving the campaign parameter and learning feedback from the user via the user interface module. The method may include a step of providing an instructional content to the user based on campaign parameter via the education module. The method may include a step of adjusting the instructional content based on the learning feedback via the education module. The method may include a step of generating a campaign via the campaign module for the user based on the campaign parameter. The method may include a step of analyzing the campaign via the analytics module based on an advertisement metric to produce a campaign analysis. The method may include a step of generating a real-time performance report via the analytics module based on the campaign analysis of the campaign. The method may include a step of adjusting the campaign via the campaign module when the real-time performance report includes a determination for adjustment. The method may include a step of directing the user to view the instructional content and to provide another learning feedback when the real-time performance report includes a determination that adjusting the campaign requires an understanding of the user.

In certain embodiments, a non-transitory computer-readable medium storing processor instructions for digital marketing analysis and management for a user is provided. When executed by a processor, the processor instructions may cause the processor to receive a campaign parameter and learning feedback from the user, provide an instructional content to the user based on the campaign parameter, and adjust the instructional content based on the learning feedback. The processor instructions may cause the processor to generate a campaign for the user based on the campaign parameter, analyze the campaign based on an advertisement metric to produce a campaign analysis, and generate a real-time performance report based on the campaign analysis of the campaign. The processor instructions may cause the processor to adjust the campaign when the real-time performance report includes a determination for adjustment and direct the user to view the instructional content and provide another learning feedback when the real-time performance report includes a determination that adjusting the campaign requires an understanding of the user.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations and are not intended to limit the scope of the present disclosure.

FIG. 1 is a block diagram illustrating an embodiment of a digital marketing analysis and management system;

FIG. 2 is a block diagram illustrating an embodiment of a digital marketing analysis and management system;

FIG. 3 is a block diagram illustrating an embodiment of a digital marketing analysis and management system;

FIG. 4 is a block diagram illustrating an embodiment of a digital marketing analysis and management system;

FIG. 5 illustrates multiple dashboard elements of a graphical user interface of an application for digital marketing analysis and management;

FIG. 6 illustrates multiple dashboard elements of a graphical user interface of an application for digital marketing analysis and management;

FIG. 7 illustrates multiple dashboard elements of a graphical user interface of an application for digital marketing analysis and management;

FIG. 8 illustrates multiple dashboard elements of a graphical user interface of an application for digital marketing analysis and management;

FIGS. 9A and 9B provide a flowchart illustrating an embodiment of a method for digital marketing analysis and campaign management;

FIG. 10 provides a flowchart extending from FIGS. 9A and 9B and further illustrates the method for digital marketing analysis and campaign management;

FIG. 11 provides a flowchart extending from FIGS. 9A and 9B and further illustrates the method for digital marketing analysis and campaign management;

FIG. 12 provides a flowchart extending from FIGS. 9A and 9B and further illustrates the method for digital marketing analysis and campaign management;

FIG. 13 provides a flowchart extending from FIGS. 9A and 9B and further illustrates the method for digital marketing analysis and campaign management; and

FIG. 14 provides a flowchart extending from FIGS. 9A and 9B and further illustrates the method for digital marketing analysis and campaign management.

### DETAILED DESCRIPTION

The following description of technology is merely exemplary in nature of the subject matter, manufacture, and use of one or more inventions, and is not intended to limit the scope, application, or uses of any specific invention claimed in this application or in such other applications as may be filed claiming priority to this application, or patents issuing therefrom. Regarding methods disclosed, the order of the steps presented is exemplary in nature, and thus, the order of the steps can be different in various embodiments, including where certain steps can be simultaneously performed, unless expressly stated otherwise. “A” and “an” as used herein indicate “at least one” of the item is present; a plurality of such items may be present, when possible. Except where otherwise expressly indicated, all numerical quantities in this description are to be understood as modified by the word “about” and all geometric and spatial descriptors are to be understood as modified by the word “substantially” in describing the broadest scope of the technology. “About” when applied to numerical values indicates that the calculation or the measurement allows some slight imprecision in the value (with some approach to exactness in the value; approximately or reasonably close to the value; nearly). If, for some reason, the imprecision provided by “about” and/or “substantially” is not otherwise understood in the art with this ordinary meaning, then “about” and/or “substantially” as used herein indicates at least variations that may arise from ordinary methods of measuring or using such parameters.

Although the open-ended term “comprising,” as a synonym of non-restrictive terms such as including, containing, or having, is used herein to describe and claim embodiments of the present technology, embodiments may alternatively be described using more limiting terms such as “consisting of” or “consisting essentially of.” Thus, for any given embodiment reciting materials, components, or process steps, the present technology also specifically includes embodiments consisting of, or consisting essentially of, such materials, components, or process steps excluding additional materials, components or processes (for consisting of) and excluding additional materials, components or processes affecting the significant properties of the embodiment (for consisting essentially of), even though such additional materials, components or processes are not explicitly recited in this application. For example, recitation of a composition or process reciting elements A, B and C specifically envisions embodiments consisting of, and consisting essentially of, A, B and C, excluding an element D that may be recited in the art, even though element D is not explicitly described as being excluded herein.

As referred to herein, disclosures of ranges are, unless specified otherwise, inclusive of endpoints and include all distinct values and further divided ranges within the entire range. Thus, for example, a range of “from A to B” or “from about A to about B” is inclusive of A and of B. Disclosure of values and ranges of values for specific parameters (such as amounts, weight percentages, etc.) are not exclusive of other values and ranges of values useful herein. It is envisioned that two or more specific exemplified values for a given parameter may define endpoints for a range of values that may be claimed for the parameter. For example, if Parameter X is exemplified herein to have value A and also exemplified to have value Z, it is envisioned that Parameter X may have a range of values from about A to about Z. Similarly, it is envisioned that disclosure of two or more ranges of values for a parameter (whether such ranges are nested, overlapping or distinct) subsume all possible combination of ranges for the value that might be claimed using endpoints of the disclosed ranges. For example, if Parameter X is exemplified herein to have values in the range of 1-10, or 2-9, or 3-8, it is also envisioned that Parameter X may have other ranges of values including 1-9, 1-8, 1-3, 1-2, 2-10, 2-8, 2-3, 3-10, 3-9, and so on.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

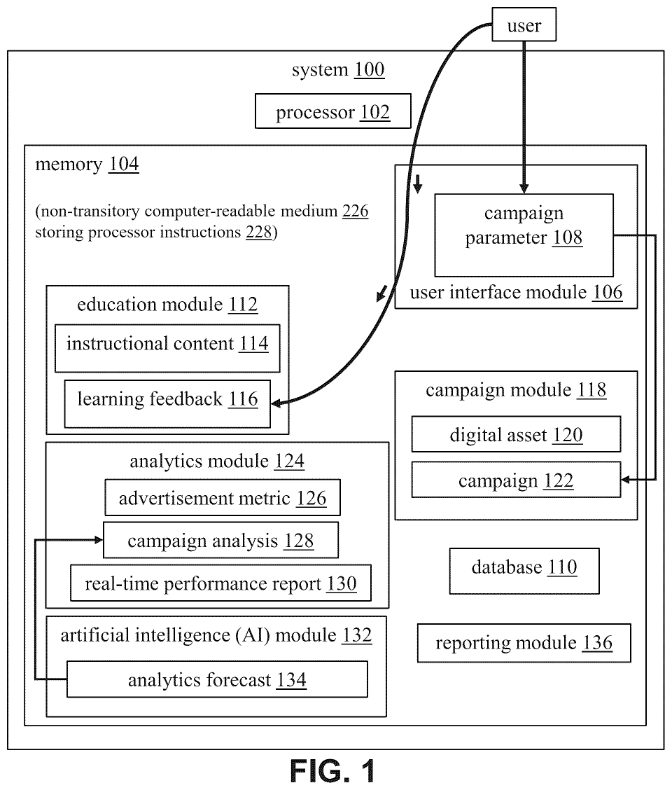

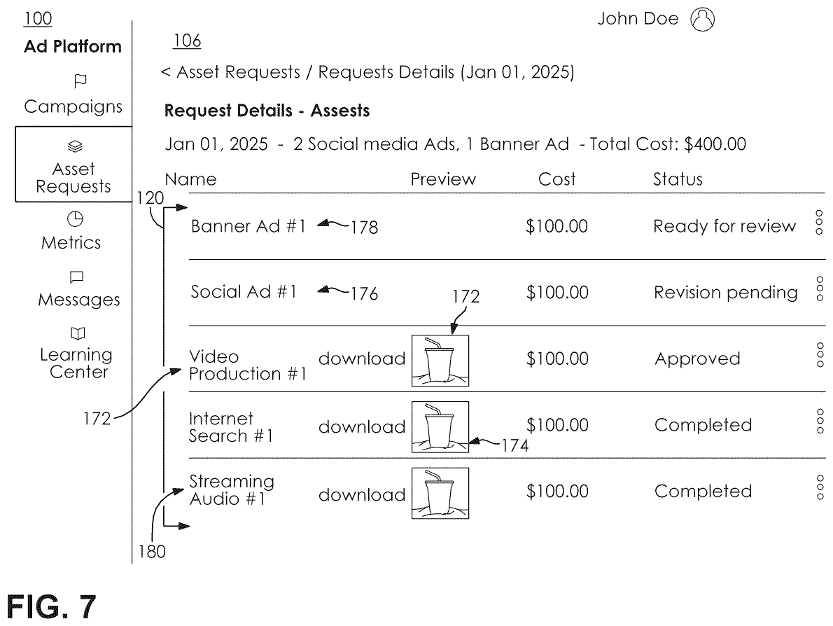

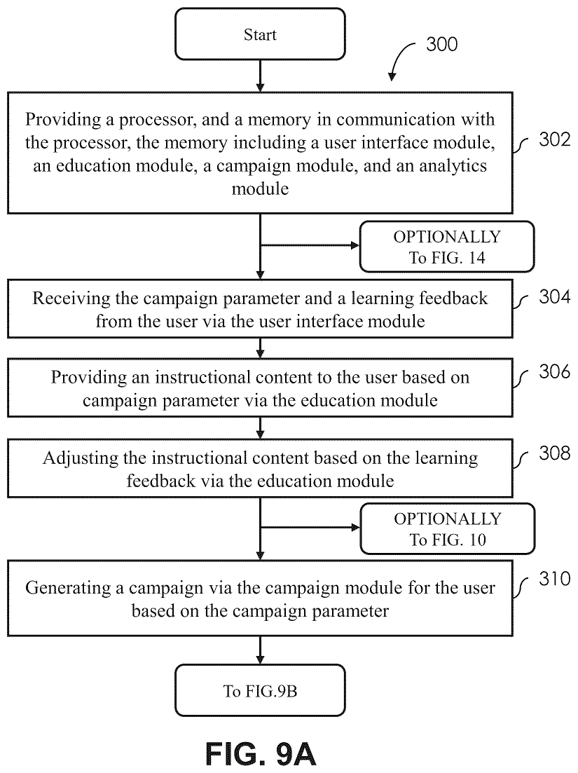

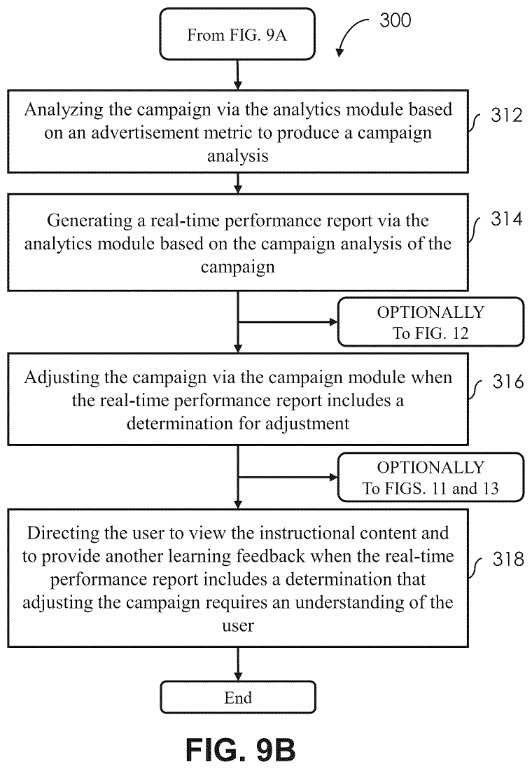

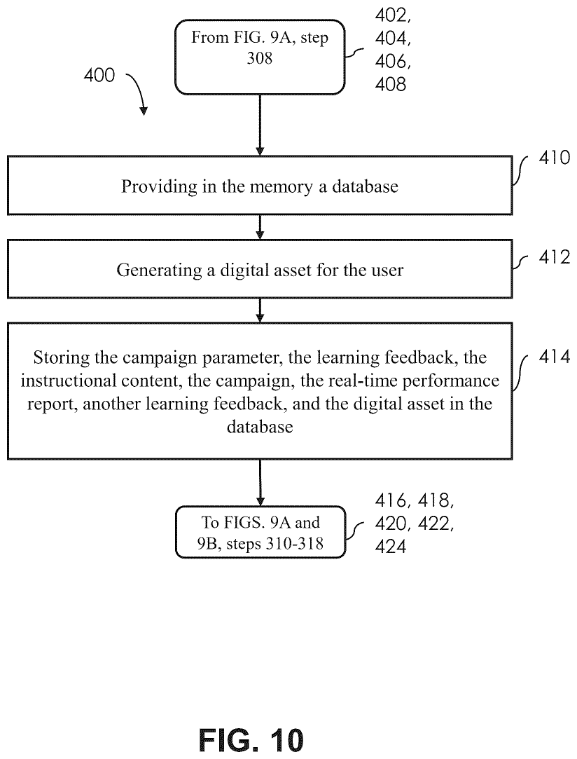

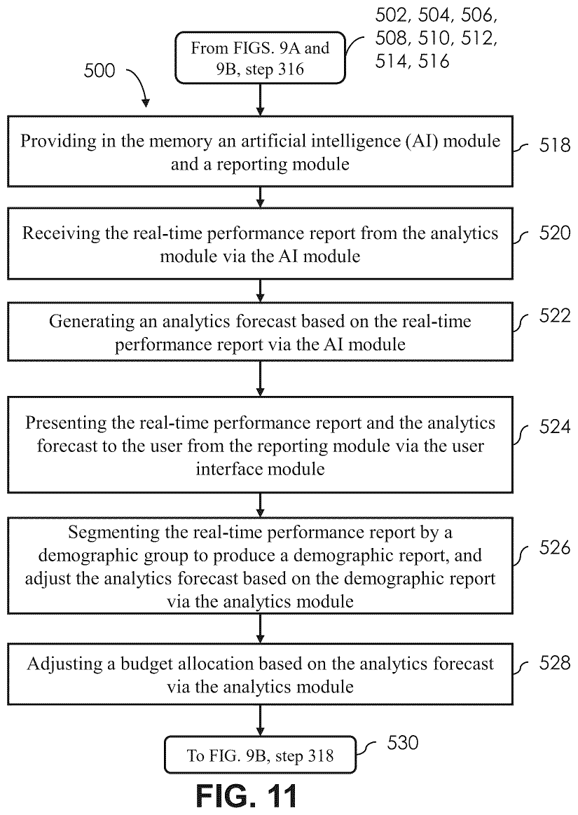

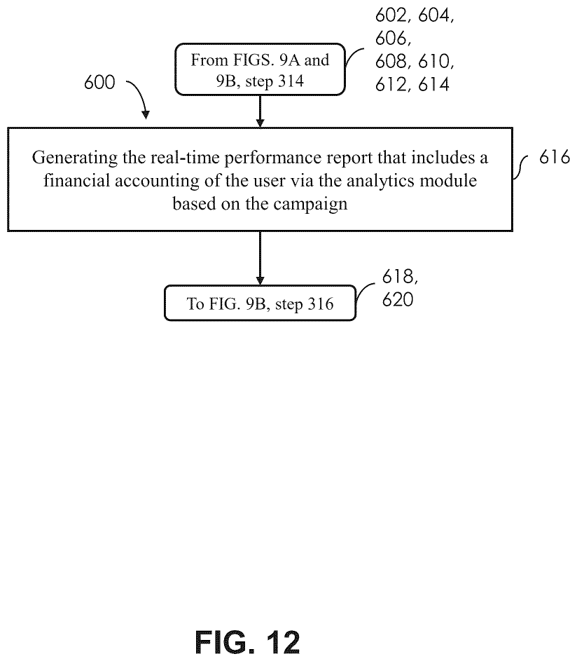

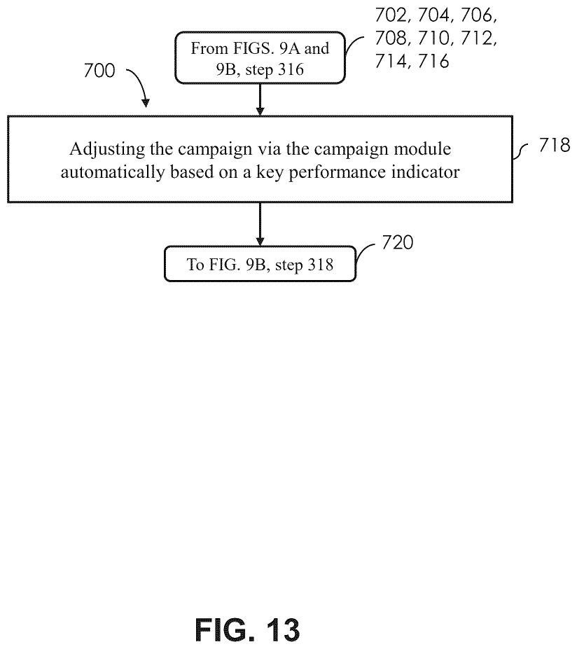

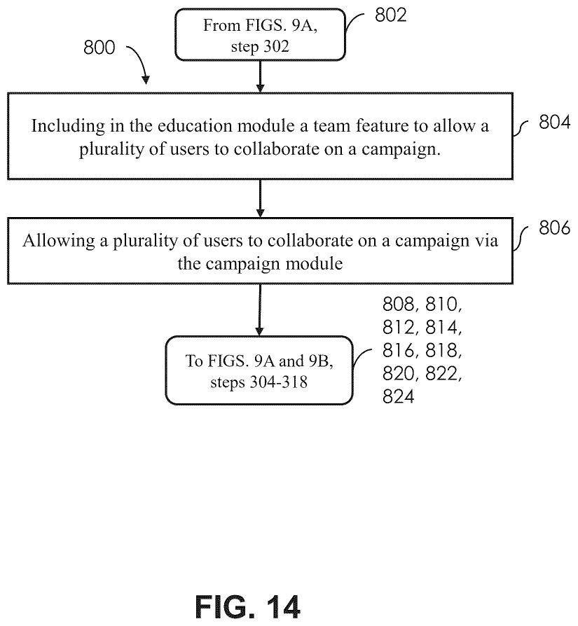

The present technology provides an advanced system 100 for digital marketing analysis and management, aspects of which are shown generally in accompanying FIGS. 1-8. A method 300 for digital marketing analysis and campaign management is also disclosed, aspects of which are shown in FIGS. 9A and 9B. Another method 400 for digital marketing analysis and campaign management is disclosed in FIG. 10. Another method 500 for digital marketing analysis and campaign management is disclosed in FIG. 11. And another method 600 for digital marketing analysis and campaign management is also disclosed in FIG. 12. Another method 700 for digital marketing analysis and campaign management is also disclosed in FIG. 13. And yet another method 800 for digital marketing analysis and campaign management is disclosed in FIG. 14.

The system 100 and methods 300, 400, 500, 600, 700, and 800 allow a user to manage a digital marketing campaign and receive real-time analysis of the performance of the campaign. As shown in FIGS. 1-8, the system 100 may include a processor 102 and a memory 104 in communication with the processor 102. The memory 104 may include a user interface module 106 to receive a campaign parameter 108. The memory 104 may include a database 110 for storing the campaign parameter 108. The memory 104 may include an education module 112 to provide an instructional content 114 to the user, tailored to the campaign parameter 108, and adjust instructional content 114 based on learning feedback 116 from the user. The memory 104 may include a campaign module 118 that may allow the user to upload a digital asset 120 via the user interface module 106 and generate a campaign 122 for the user based on the campaign parameter 108. The memory 104 may include an analytics module 124 that may analyze the campaign 122 based on an advertisement metric 126 to produce a campaign analysis 128 and generate a real-time performance report 130 based on the campaign analysis 128 of the campaign 122. The memory 104 may include an artificial intelligence (AI) module 132 that may generate an analytics forecast 134 based on the real-time performance report 130. The memory 104 may include a reporting module 136 to present the real-time performance report 130 and the analytics forecast 134 to the user via the user interface module 106.

The processor 102 may be located on a local system 100 or a remote system 100 server accessed via a network. The remote system 100 server may be the central hub of the system 100, containing the processor 102 and memory 104 that store and execute the modules necessary for processing input date. One skilled in the art will also appreciate that the processor 102 may include one or more processors 102 and may process information and executing instructions or operation. For example, the processor 102 may include a central processing unit (CPU), a microprocessor 102, a microcontroller, or a system-on-a-chip 100, a digital signal processor 102 (DSPs), field-programmable gate arrays (FPGAs), application-specific integrated circuits (ASICs), or processors 102 based on a multi-core processor 102 architecture. One or more processors 102 may mean a single processor 102 or multiple processors 102 in a single processing unit, e.g., a central processing unit, or multiple processing units, e.g., a central processing unit and a graphics processing unit, or a central processing unit and a memory 104 manager. The processor 102 may include multiple processors 102 where one processor 102 is capable of executing one or more of the elements described in this disclosure, and a subsequent processor 102 or processors 102 may execute other elements as described herein, capable of executing all elements only in combination. One or more of the processors 102 may be remote from the at least one system 100 server.

The memory 104 may store or otherwise include one or more databases 110. The memory 104 can include one or more memories 104 and of any type suitable to the local application environment and can be implemented using any suitable volatile or nonvolatile data storage technology such as a semiconductor-based memory 104 device, a magnetic memory 104 device and system 100, an optical memory 104 device and system 100, fixed memory 104, and removable memory 104. For example, the memory 104 may include any combination of random-access memory 104 (RAM), read only memory 104 (ROM), static storage such as a magnetic or optical disk, hard disk drive (HDD), or any other type of non-transitory machine or computer readable media.

With reference to FIGS. 1-3 and 5-8, the user interface module 106 may serve as an interface for the system 100. The user interface module 106 may serve as the point of interaction between a user and the system 100 and interact with hardware including various output devices 138 that may display a representation of the user interface module 106 for observation by the user, where such an output device 138 may include, for example, one or more computer screen, speaker, tablet screen, or other view/audio port, an input device 140 such as a keyboard, microphone, and the like. The user interface module 106 may be accessible to the user, for example, via a desktop application, smartphone or mobile application, web interface, or API, and may interface with mobile SMS, social platforms, or email automation tools. The user interface module 106 may be designed to be intuitive and user-friendly, for example, with custom user preferences and accessibility requirements, allowing the user to easily upload, type, or choose a retrieved or generated campaign parameter 108. The user interface module 106 may receive the campaign parameter 108 from the user for further processing by system 100, and for use in the campaign 122.

The campaign parameter 108 may guide the configuration and execution of a campaign 122 within the system 100. The campaign parameter 108 may include input data 142 relating to the desired campaign 122 of the user, for example, a target audience, a budget, one or more advertising objectives, or a geographic reach. The campaign parameter 108 may also include a digital asset 120 that the user desires to integrate into the campaign 122. The campaign parameter 108 may be received by the user interface module 106 and transferred to the campaign module 118. The campaign parameter may be utilized to tailor the structure and content of a campaign 122 that aligns with the specified marketing strategy of the user.

With reference to FIG. 1, the database 110 may receive and store input data 142 relating to the user, or data relating to the campaign 122, the education module 112, the campaign module 118, the analytics module 124, or to the AI module 132. The database 110 may include a local database 144, a database 110 saved on a remote server 146 and accessed via a network 148, such as cloud server, or a combination local and remote database 110 as required by the system 100. The database 110 may include a relational database 150, for example, data saved in a structured form, e.g. a structured query language (SQL) table, a comma-separated values (CSV) file, or in JavaScript object notation (JSON), or a JSON-related object or map, or object storage. The database 110 may include a vector database 152 or vector store for storing vector embeddings, e.g. flexible, meaning-based, probabilistic numerical representations of data that capture semantic meaning, allowing the AI module 132 to compare similarities between different types of data. The database 110 may also include a general storage database 154 to store, for example, unstructured data such as HTML, text, raw transcripts, chat logs, images, audio files, or social media posts.

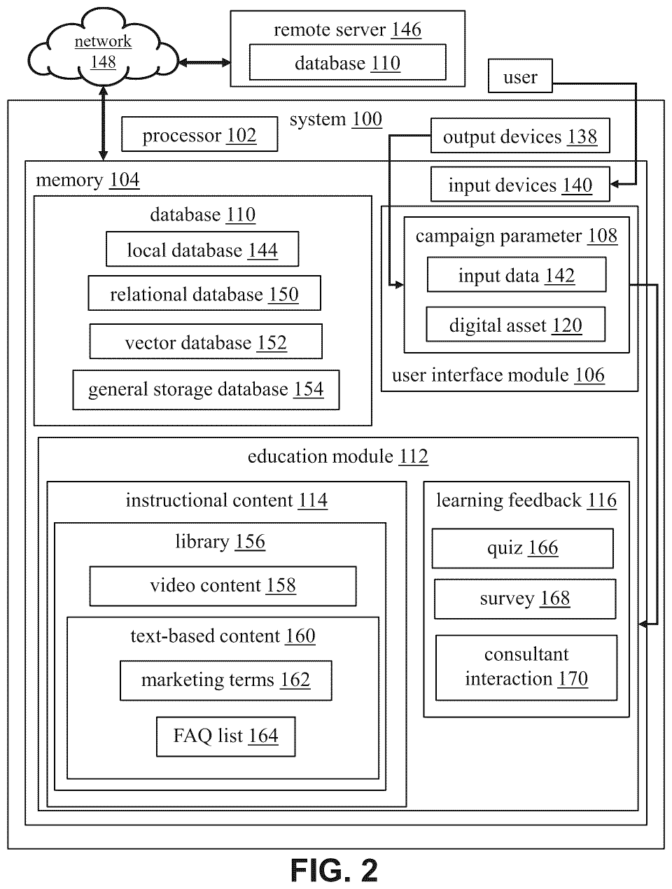

As shown in FIG. 2, the education module 112 may provide instructional content 114 to the user and may tailor the instructional content 114 based on the received campaign parameter 108. The education module 112 may present the instructional content 114 in a manner that supports incremental learning, allowing a user to gradually build marketing proficiency through successive engagements with the educational materials. To facilitate access to the instructional content 114, the education module 112 may include a library 156 that may store the instructional content 114, providing an adaptive learning environment based on the campaign parameter 108, assisting in the practical application of theoretical knowledge. The education module 112 may receive the learning feedback 116 via the user interface module 106, reflecting the comprehension of the user and progress within the education module 112. The education module 112 may adjust the instructional content 114 in response to the learning feedback 116 from the user, ensuring that the instructional content 114 aligns with the ongoing marketing requirements and comprehension level of the user. Adjusting the instructional content 114 based on the learning feedback 116 may also allow the educational material to remain relevant and directly applicable to the ongoing campaign activities of the user. It should be appreciated that the education module 112 may serve as a dynamic repository of marketing resources, supporting users through an adaptable learning environment, and enhancing user engagement by adapting the instructional content 114 based on the learning feedback 116 and campaign parameter 108.

The instructional content 114 may guide users through the intricacies of digital marketing strategies within the system 100. The instructional content 114 may include video content 158 such as video tutorials, offering step-by-step guidance on various aspects of digital marketing. The video content 158 may be tailored to align with the campaign parameter 108 provided by the user and may be accessed at any time through the user interface module 106. The instructional content 114 may include text-based content 160 such as a list of marketing terms 162 or a FAQ list 164, allowing a user to access concise answers to common questions, enhancing their understanding of complex marketing concepts. The instructional content 114 may adapt dynamically via the learning feedback 116 received from a user, allowing a user to develop and refine marketing skills incrementally, thereby optimizing campaign 122 outcomes. Through a systematic approach that evolves with each user's engagement, the instructional content 114 may provide a source for both theoretical knowledge and its application in real-world marketing scenarios.

The learning feedback 116 may facilitate the adaptation of instructional content 114 within the education module 112. The learning feedback 116 may be received via the user interface module 106 and may provide insight into the understanding of the user and engagement with the educational material. In other words, the learning feedback 116 may be utilized to adjust the instructional content 114 to better align with the developing knowledge base of the user. The learning feedback 116 may include a quiz 166, a survey 168, or a consultant interaction 170. Through continuous collection and analysis of the learning feedback 116, the system 100 may support a dynamic and responsive educational experience, promoting deeper learning and more effective campaign execution.

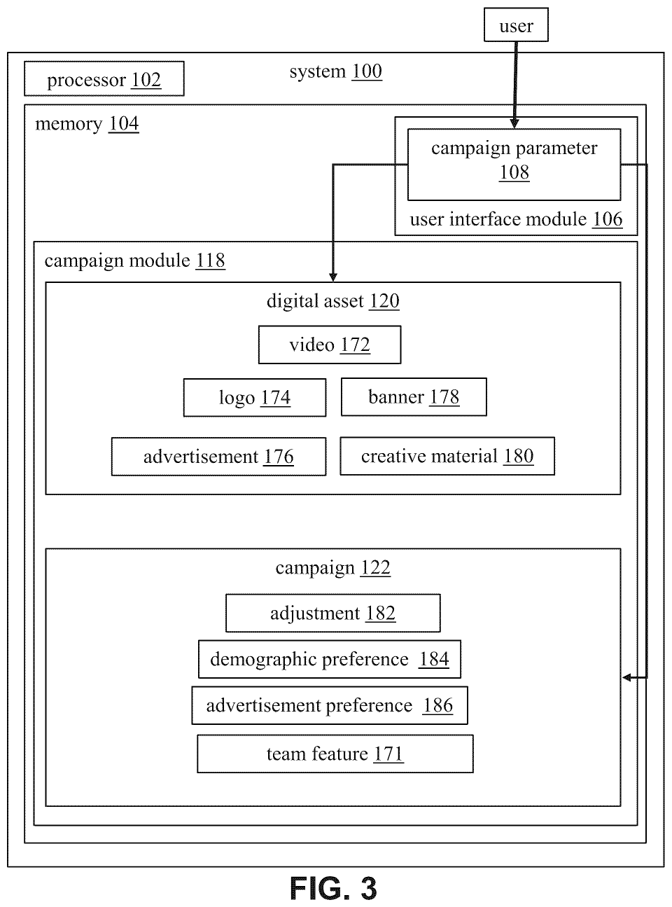

As shown in FIG. 3, the campaign module 118 may generate a campaign 122 by receiving a campaign parameter 108 from the user interface module 106. In other words, the campaign module 118 may produce a campaign 122 tailored to the needs of the user, based on the input campaign parameter 108. The campaign module 118 may generate digital asset 120 for the user, utilizing the campaign parameter 108 provided through the user interface module 106. The process of the digital asset 120 generation may include analyzing the predefined campaign parameter 108 to tailor the digital asset 120 to meet the specific requirements outlined by the user, which may encompass, for example, target demographic preferences, thematic messaging, and alignment with established marketing objectives. The campaign module 118 may rely on historical input data 142 from the user to optimize the digital asset 120 and to enhance user engagement and brand visibility and support the desired marketing outcomes. The digital asset 120 may be stored within the database 110 to facilitate easy retrieval and integration within the campaign 122. The campaign module 118 may include a team feature 171 to allow a plurality of users to collaborate on a campaign 122. It should be appreciated that the generation and customization of digital assets 120 may provide the user with a comprehensive collection of cohesive and targeted marketing materials.

The digital asset 120 may be provided by the user via the user interface module 106 or may be generated for the user via the campaign module 118 or the AI module 132, depending on the needs of the user. For example, the digital asset 120 may be an aspect of the campaign parameter 108 or provided by the user with other input data 142. The digital asset 120 may include elements such as a video 172, logo 174, advertisement 176, banner 178, or other creative material 180 necessary for executing an effective digital marketing strategy. The system 100 may also incorporate the advice or assistance of a consultant for generating the digital asset 120 depending on the specific requirements of the campaign 122 or the preference of the user. The digital asset 120 may be stored in the database 110 for the use of a current or future campaign 122 and accessed by the user via the user interface module 106.

The campaign 122 may be built by the campaign module 118 utilizing the campaign parameter 108. Upon receiving the campaign parameter 108, the campaign 122 may be built in alignment with the objectives defined by the user. The campaign 122 may be continuously analyzed and may be adjusted as needed by the campaign module 118 upon the determination for an adjustment 182, ensuring that the campaign 122 remains efficient and aligns with the target outcomes. The campaign 122 may include a demographic preference 184 for accurately delivering the digital asset 120 to the target audience, e.g. customer demographics, geo markets, cookies, interests, behaviors, look alike audiences, etc., based on the initial input data 142 of the user. The campaign 122 may include an advertisement preference 186, e.g. market area, business objectives, comparable campaigns 122, budget, flight dates, etc. The user may also seek the advice and assistance of a consultant through the system 100 depending on the specific requirements of the campaign 122. The user may also be prompted to engage with instructional content 114 provided by the education module 112 to enhance their understanding of the campaign 122 and provide further learning feedback 116, fostering ongoing optimization of the campaign 122 strategy and allowing the user to make informed decisions in real-time. It should be appreciated that the combination of present and historical input data 142 from the user, look alike audiences, comparable campaigns 122, and experienced consultants may provide the user with accurate market area and audiences for a successful campaign 122. Upon building the campaign 122, the user may ‘traffic’ the campaign 122, e.g. displaying a banner 178, video 172, logo 174, or other creative material 180 on social media or Google® search ads. The campaign 122 may traffic a digital asset 120, for example, to local target demographics 194, displaying videos 172 or other creative material 180 on digital billboards on the side of local roads and highways, on market kiosks, in hotel lobbies, and in sports bars. For example, the campaign 122 may also utilize an audio-based digital asset 120 in the form of a soundbite or musical slogan (e.g. a jingle) to provide to producers of podcasts, radio shows, or influencers to include in radio or podcast episodes.

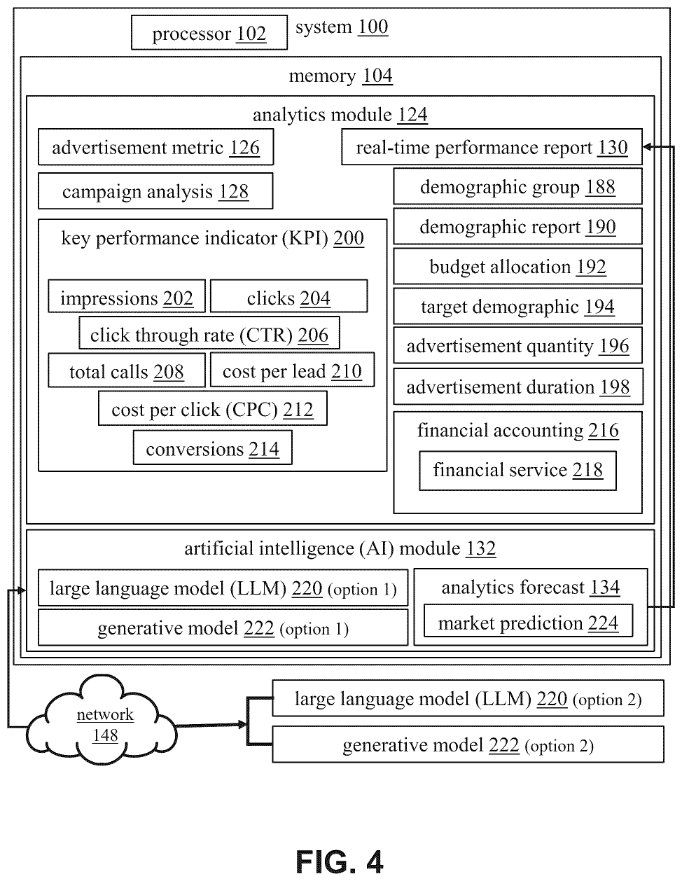

As shown in FIG. 4, the analytics module 124 may analyze the campaign 122 by utilizing an advertisement metric 126 to produce a campaign analysis 128. The campaign analysis 128 may facilitate the generation of a real-time performance report 130, which may include a determination for an adjustment 182 of the campaign 122. The analytics module 124 may also segment the real-time performance report 130 by a demographic group 188, producing a demographic report 190 for enhanced insight into campaign 122 performance. The analytics module 124 may adjust the campaign 122 based on a budget allocation 192, a target demographic 194, an increase in advertisement quantity 196, or an increase in advertisement duration 198. The analytics module 124 may provide analysis on a key performance indicator (KPI) 200 for trends and comparative analyses, including one or more impressions 202, clicks 204, click through rate (CTR) 206, total calls 208, cost per lead 210, cost-per-click (CPC) 212, or conversions 214, e.g. for determining a conversion rate. The KPI 200 may, for example, include additional metrics such as engagement, view through rate (VTR), or customer lifetime value (CLV) customer acquisition cost, or search engine optimization (SEO) KPIs, for example, search traffic, keyword ranking, backlinks, domain and page authority, bounce rate, or time on site. For example, the KPI 200 may relate to social media such as likes, comments, shares, follower growth rate, social media traffic and conversions 214, paid search marketing, quality score, email marketing, signup rate, open rate, bounce rate, or unsubscribes. Measurement of the KPI 200 by the analytics module 124 may trigger a reaction from a consultant for system 100 or may trigger the AI module 132 to make changes or pivots to the campaign 122 to reach the campaigns 122 objectives. Such analytics may also prompt the user to adjust various business activities, for example, changes in inventory volume or sales locations, changes in what raw materials to purchase, which manufacturers and/or distributors to work with, etc. It should be understood that the analytics module 124 may analyze the successes and failures of the campaign 122 through a variety of KPIs 200 and provide actionable insights for campaign 122 and business decisions.

The analytics module 124 may provide a financial accounting 216 based on the campaign 122, enabling the user to correlate marketing efforts directly with financial projections. For example, the analytics module 124 may integrate a financial service 218, such as QuickBooks, to correlate marketing efforts with financial projections. The analytics module 124 may be in communication with the financial service 218, allowing for real-time input of budget allocations and resulting revenue of the campaign 122. As the analytics module 124 processes an advertisement metric 126, the analytics module 124 may produce a campaign analysis 128 that directly relates to the financial accounting 216 of the campaign 122, determining potential financial outcomes. The integration of the financial service 218 may allow for the generation of a real-time performance report 130 that provides an up-to-date accounting and visualization of advertising effectiveness in relation to the financial goals of the user. The financial accounting 216 may be utilized for an adjustment 182 of the campaign 122, offering a comprehensive view of ROI. It should be appreciated that the integration of a financial service 218 may support an enhanced understanding of marketing efficacy, facilitate informed decision-making, and allow for adaptive adjustments 182 tailored to the campaign parameter 108.

An advertisement metric 126 may be utilized within the analytics module 124 to assess the effectiveness of a campaign 122. The advertisement metric 126 may include, for example, one or more quantifiable data points that evaluate various aspects of the advertising effort, such as one or more impressions 202, clicks 204, CTR 206, or conversions 214. The advertisement metric 126 may serve as an analytical tool to identify campaign 122 performance trends and assess audience engagement levels. The advertisement metric 126 may allow for the analytics module 124 to generate a campaign analysis 128 that may inform decision-making processes for an adjustment 182. It should be appreciated that the advertisement metric 126 may guide an adjustment 182 to the campaign 122 to enhance alignment with advertising objectives and improve ROI.

The campaign analysis 128 may include the results of evaluating aspects of the campaign 122 using an advertisement metric 126 to provide performance insights. For example, the advertisement metric 126 may encompass data points such as one or more impressions 202, clicks 204, and conversions 214, quantifying the effectiveness of the campaign 122. The campaign analysis 128 may be generated by the analytics module 124 to produce a real-time performance report 130 to inform decisions regarding potential alterations or adjustments 182 to the campaign 122 and improving alignment with the goals of the user. It should be appreciated that the campaign analysis 128 may allow a campaign 122 to be optimized in response to evolving market dynamics.

The real-time performance report 130 may include an organized review of the campaign analysis 128, derived from the advertisement metric 126 and generated by the analytics module 124. The real-time performance report 130 may include a determination for an adjustment 182, allowing the campaign module 118 to implement necessary changes to the campaign 122. For example, the real-time performance report 130 may facilitate timely optimizations that align with the objectives of the user by providing a campaign analysis 128 on the effectiveness of a given marketing strategy. The real-time performance report 130 may be derived by multiple advertisement metrics 126 to allow for an adjustment 182 of strategies responsively based on evolving data conditions. For example, the real-time performance report 130 may segment campaign 122 performance data by a demographic group 188 or other relevant category, offering the campaign module 118 further strategic insights for marketing adjustments 182.

As shown in FIG. 4, the AI module 132 may enhance the digital marketing analysis and management capabilities of system 100. The AI module 132 may include a large language model (LLM) 220. The LLM 220 may process the campaign parameter 108 and the real-time performance report 130 to produce an analytics forecast 134 based on results of the real-time performance report 130. Through the application of sophisticated algorithms, the AI module 132 may facilitate strategic decisions for optimization of the campaign 122 performance. For example, the AI module 132 may segment the real-time performance report 130 by a demographic group 188 to refine the analytics forecast 134 to support adjustments in the campaign 122. The AI module 132 may, for example, use natural language processing (NPL) to fine-tune the LLM 220, transform a campaign parameter 108 into a searchable format, or generate a vector embedding from a campaign parameter 108 and store the vector embedding in the database 110. The AI module 132 may include a local LLM 220, as shown in FIG. 4, option 1, or may utilize a remote LLM 220 via a network 148 as shown in FIG. 4, option 2. It should be understood that the AI module 132 may be periodically trained and fine-tuned with a campaign parameter 108 from the user to identify a wide range of data to generate the analytics forecast 134.

The AI module 132 may include a generative model 222, e.g. a convolutional neural network (CNN) for generating an image-based digital asset 120, or a recurrent neural network (RNN) or transformer model for generating a text-based digital asset 120. The AI module 132 may include a local generative model 222, as shown in FIG. 4, option 1, or may utilize a remote generative model 222 via a network 148 as shown in FIG. 4, option 2. The AI module 132 may generate the digital asset 120 for the user depending on the complexity and specific needs of the campaign 122. The AI module 132 may analyze a campaign parameter 108, campaign 122, or real-time performance report 130 to produce additional instructional content 114 for the education module 112, in order to better suit the needs of the user, providing a deeper understanding of marketing strategies and campaign 122 decisions specific to the industries of the user. It should be appreciated that integration with a generative model 222 may allow for specificity in the generation of the digital asset 120 based on the requested campaign parameter 108.

The analytics forecast 134 may allow for proactive campaign 122 management, anticipating market trends and user behaviors to optimize marketing efforts before performance issues arise. For example, the analytics forecast 134 may be determined by historical data and look-alike audiences, allowing for evolving campaign strategies and enhancing overall marketing effectiveness. Aspects of the analytics forecast 134 may be determined by a market prediction 224 sourced from the amalgamation of real-time performance reports 130 from similar campaigns 122. It should be appreciated that the analytics forecast 134 may provide the user with the foresight on how the audience will react and engage the campaign 122.

The reporting module 136 may present both the real-time performance report 130 and the analytics forecast 134 to the user through the user interface module 106. The reporting module 136 may also provide the user with the advertisement metric 126 or the campaign analysis 128 in order to allow the user to troubleshoot or alter the campaign 122 strategy. For example, the reporting module 136 may facilitate the delivery of comprehensive insights regarding advertising initiatives, allowing the user to effectively monitor the performance of the campaign 122. The reporting module 136 may notify the user of a newly generated digital asset 120. The reporting module 136 may prompt a user to review instructional content 114 provided by the education module 112 and prompt the user to submit additional learning feedback 116 if necessary to facilitate further campaign 122 adjustments 182. By displaying the real-time performance report 130 and analytics forecast 134, the reporting module 136 may visually assist the user in evaluating the effectiveness of the campaign 122 strategy.

As shown in FIGS. 9A and 9B, a method 300 for digital marketing analysis and management for a user is provided. The method 300 may include a step 302 of providing a processor 102 and a memory 104 in communication with the processor 102. The memory 104 may include a user interface module 106, an education module 112, a campaign module 118, and an analytics module 124. The user interface module 106 may receive a campaign parameter 108 and learning feedback 116 from the user. The education module 112 may provide an instructional content 114 to the user based on the campaign parameter 108 and may make an adjustment 182 to the instructional content 114 based on the learning feedback 116. The campaign module 118 may receive the campaign parameter 108 from the user interface module 106 and may generate a campaign 122 for the user based on the campaign parameter 108. The analytics module 124 may analyze the campaign 122 based on an advertisement metric 126 to produce a campaign analysis 128 and may generate a real-time performance report 130 based on the campaign analysis 128 of the campaign 122. The campaign module 118 may also receive the real-time performance report 130 from the analytics module 124, may adjust 182 the campaign 122 when the real-time performance report 130 includes a determination for adjustment 182, and may direct the user to view the instructional content 114 and provide another learning feedback 116 when the real-time performance report 130 includes a determination that adjusting 182 the campaign 122 requires an understanding of the user.

The method 300 may include a step 304 of receiving the campaign parameter 108 and learning feedback 116 from the user via the user interface module 106. The method 300 may include a step 306 of providing an instructional content 114 to the user based on the campaign parameter 108 via the education module 112. The method 300 may include a step 308 of adjusting the instructional content 114 based on the learning feedback 116 via the education module 112. The method 300 may include a step 310 of generating a campaign 122 via the campaign module 118 for the user based on the campaign parameter 108. The method 300 may include a step 312 of analyzing the campaign 122 via the analytics module 124 based on an advertisement metric 126 to produce a campaign analysis 128. The method 300 may include a step 314 of generating a real-time performance report 130 via the analytics module 124 based on the campaign analysis 128 of the campaign 122. The method 300 may include a step 316 of adjusting 182 the campaign 122 via the campaign module 118 when the real-time performance report 130 includes a determination for adjustment 182. The method 300 may include a step 318 of directing the user to view the instructional content 114 and to provide another learning feedback 116 when the real-time performance report 130 includes a determination that adjusting 182 the campaign 122 requires an understanding of the user.

As shown in FIG. 10, a method 400 for digital marketing analysis and management for a user is provided. The method 400 may include steps 302-308 of method 300 (as steps 402-408 respectively). The method 400 may include a step 410 of providing in the memory 104 a database 110. The database 110 may store the campaign parameter 108, the learning feedback 116, the instructional content 114, the campaign 122, the real-time performance report 130, another learning feedback 116, and a digital asset 120. The campaign module 118 may generate the digital asset 120 for the user. The method 400 may include a step 412 of generating the digital asset 120 for the user. The method 400 may include a step 414 of storing the campaign parameter 108, the learning feedback 116, the instructional content 114, the campaign 122, the real-time performance report 130, another learning feedback 116, and the digital asset 120 in the database 110. The method 400 may include steps 310-318 of method 300 (as steps 416-424 respectively).

As shown in FIG. 11, a method 500 for digital marketing analysis and management for a user is provided. The method 500 may include steps 302-316 of method 300 (as steps 502-516 respectively). The method 500 may include a step 518 of providing in the memory 104 an artificial intelligence (AI) module 132 and a reporting module 136. The AI module 132 may receive the real-time performance report 130 from the analytics module 124, and generate an analytics forecast 134 based on the real-time performance report 130. The reporting module 136 may present the real-time performance report 130 and the analytics forecast 134 to the user via the user interface module 106. The analytics module 124 may segment the real-time performance report 130 by a demographic group 188 to produce a demographic report 190. The analytics module 124 may adjust 182 the analytics forecast 134 based on the demographic report 190 and adjust 182 a budget allocation 192 based on the analytics forecast 134. The method 500 may include a step 520 of receiving the real-time performance report 130 from the analytics module 124 via the AI module 132. The method 500 may include a step 522 of generating an analytics forecast 134 based on the real-time performance report 130 via the AI module 132. The method 500 may include a step 524 of presenting the real-time performance report 130 and the analytics forecast 134 to the user from the reporting module 136 via the user interface module 106. The method 500 may include a step 526 of segmenting the real-time performance report 130 by a demographic group 188 to produce a demographic report 190, and adjust the analytics forecast 134 based on the demographic report 190 via the analytics module 124. The method 500 may include a step 528 of adjusting a budget allocation 192 based on the analytics forecast 134 via the analytics module 124. The method 500 may include step 318 of method 300 (as step 530 respectively).

As shown in FIG. 12, a method 600 for digital marketing analysis and management for a user is provided. The method 600 may include steps 302-314 of method 300 (as steps 602-614 respectively). The analytics module 124 may include in the real-time performance report 130 a financial accounting 216 of the user based on the campaign 122. The method 600 may include a step 616 of including in the real-time performance report 130 a financial accounting 216 of the user via the analytics module 124 based on the campaign 122. The method 600 may include steps 316-318 of method 300 (as steps 618-620 respectively).

As shown in FIG. 13, a method 700 for digital marketing analysis and management for a user is provided. The method 700 may include steps 302-316 of method 300 (as steps 702-716 respectively). The campaign module 118 may automate the adjustment 182 of the campaign 122 based on a key performance indicator (KPI) 200. The method 700 may include a step 718 of adjusting 182 the campaign 122 via the campaign module 118 automatically based on the KPI 200. The method 700 may include step 318 of method 300 (as step 720 respectively).

As shown in FIG. 14, a method 800 for digital marketing analysis and management for a user is provided. The method 800 may include step 302 of method 300 (as step 802 respectively). The method 800 may include a step 804 of including in the education module 112 a team feature 171 to allow a plurality of users to collaborate on a campaign 122. The method 800 may include a step 806 of allowing a plurality of users to collaborate on a campaign 122 via the campaign module 118. The method 800 may include steps 304-318 of method 300 (as steps 808-824 respectively).

The system 100 may include a non-transitory computer-readable medium 226 storing processor instructions 228 for digital marketing analysis and management for a user. When executed by a processor 102, the processor instructions 228 may cause the processor 102 to receive a campaign parameter 108 and learning feedback 116 from the user, provide an instructional content 114 to the user based on the campaign parameter 108, and adjust 182 the instructional content 114 based on the learning feedback 116. The processor instructions 228 may cause the processor 102 to generate a campaign 122 for the user based on the campaign parameter 108, analyze the campaign 122 based on an advertisement metric 126 to produce a campaign analysis 128, and generate a real-time performance report 130 based on the campaign analysis 128 of the campaign 122. The processor instructions 228 may cause the processor 102 to adjust the campaign 122 when the real-time performance report 130 includes a determination for adjustment 182 and direct the user to view the instructional content 114 and provide another learning feedback 116 when the real-time performance report 130 includes a determination that adjusting 182 the campaign 122 requires an understanding of the user.

Advantageously, the present technology may address the inefficiencies and limitations of other marketing systems by providing a unified platform that automates the integration of instructional content 114 with real-time analytics and adaptive campaign 122 adjustments 182. Through real-time adaptability facilitated by the user interface, education, campaign 122, and analytics module 124, users may be empowered to apply theoretical marketing knowledge practically and effectively, minimizing the disconnect that often leads to suboptimal campaign 122 performance. The capability of the system 100 to integrate marketing campaigns 122 with financial service 218 may provide entrepreneurs and investors with accurate, data-driven strategies rather than speculative approaches. The system 100 not only offers a seamless transition from educational resources to practical execution but also eliminates barriers for small start-ups, providing an accessible and robust solution to optimize marketing strategies while achieving maximum return on investment.

### EXAMPLES

Example embodiments of the present technology are provided with reference to the FIGS. 1-14 enclosed herewith.

### Example 1: Entrepreneur Development Center Screening

An economic development center services 50+ entrepreneurs in the local community equips individuals with the tools, skills, and support to transform ideas into successful businesses, addressing market demands and boosting economic growth. The development center invests in a subscription to the system 100 for each entrepreneur serviced by the development center.

An entrepreneur may begin by signing up for a membership with the system 100 in order to unlock tools to market a business, create and execute marketing strategies, and analyze the effectiveness of a campaign 122 and how the campaign 122 directly impacts a proforma. With the education module 112, the entrepreneur may watch instructional content 114 to understand how to create a brand and develop a message tailored to a demographic group 188. This may be facilitated through video content 158 and text-based content 160 such as brief text, video tutorials and requesting learning feedback 116 from the entrepreneur such to check for understanding after each topic is completed. As the entrepreneur completes a section of the instructional content 114, the entrepreneur may learn how to market a business and how to create and execute a campaign 122 through a campaign 122 builder. The entrepreneur may strategize the campaign 122 to a target demographic 194 and analyze the results of the campaign 122 via the analytics module 124.

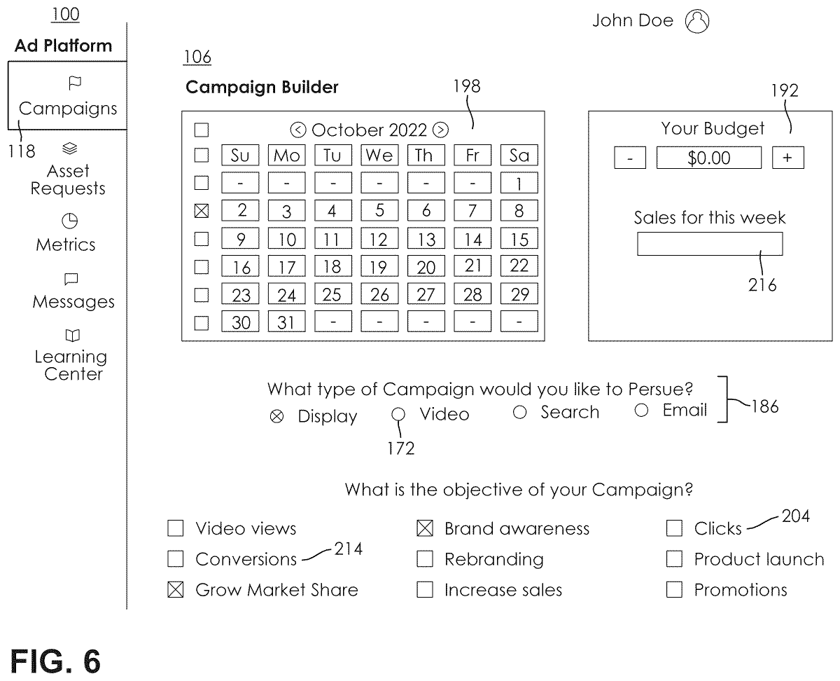

Using the campaign module 118, the entrepreneur may build a marketing campaign 122, as shown in FIG. 6. The entrepreneur may enter a campaign parameter 108 to deliver advertisements to target demographic 194 for specific geographic markets, cookies, interests, or behaviors. The campaign module 118 may further suggest and advise the entrepreneur where and who to target based on campaign parameter 108 of the entrepreneur, for example, if the entrepreneur includes a specific market area, business objectives, budget, flight dates, or other appropriately desired metrics. Using historical data, the campaign module 118 may utilize look alike audiences, comparable campaigns 122, and historical campaign 122 data to give an accurate market area and audience for the marketing campaign 122. The campaign module 118 may provide the entrepreneur with a financial accounting 216 to track the effectiveness of the campaign 122 based on real-time sales reports.

After the campaign 122 is built, the entrepreneur may have an option to traffic the advertisement to the target demographic 194. This may include, for example, displaying a banner 178, a video 172, other creative material 180 such as social media content, and/or Google® search advertisements 176. If the entrepreneur already has a digital asset 120, the entrepreneur may upload the digital asset 120 to the user interface module 106 via a smart device. Alternately, the entrepreneur may choose from or schedule an update from the library 156 if the entrepreneur has previously used the system 100. If the entrepreneur does not have a digital asset 120, the campaign module 118 may generate a digital asset 120 for the entrepreneur. This may be done through the analytics module 124 depending on the complexity of the campaign 122, or through the AI module 132 utilizing historically compiled data based on previous marketing campaigns 122.

Once the marketing campaign 122 is launched, the AI module 132 may track the campaign 122 data and analytics in real time. As the AI module 132 collects data throughout the campaign 122, the analytics module 124 may analyze the success and failure based on a variety of KPIs 200, such as described above. Analysis of an individual KPI 200 may trigger a response from the analytics module 124 to make a change or pivot the marketing campaign 122 based on the objectives of the entrepreneur. For example, the analytics module 124 may calculate the number of times an individual sees an advertisement within a given time period, i.e., the frequence of advertisement views, to make a purchase. The analytics module 124 may then calculate a number of impressions 202 to deliver the correct frequency to a target demographic 194. If the campaign 122 is underperforming, the analytics module 124 may, for example, determine an additional market area to include in the marketing campaign 122 or pivot to a different market area, based on a population of a target demographic 194 within a market area. The analytics module 124 may also determine that product pricing may need to be adjusted in certain market areas and suggest that the entrepreneur employs dynamic pricing based on the target demographic 194 and flight dates. The entrepreneur, in turn, lowers prices during the weekdays, and increases prices during weekend days where the target demographic 194 has shown a pattern of increased online presence based on the number of one or more impressions 202 tracked.

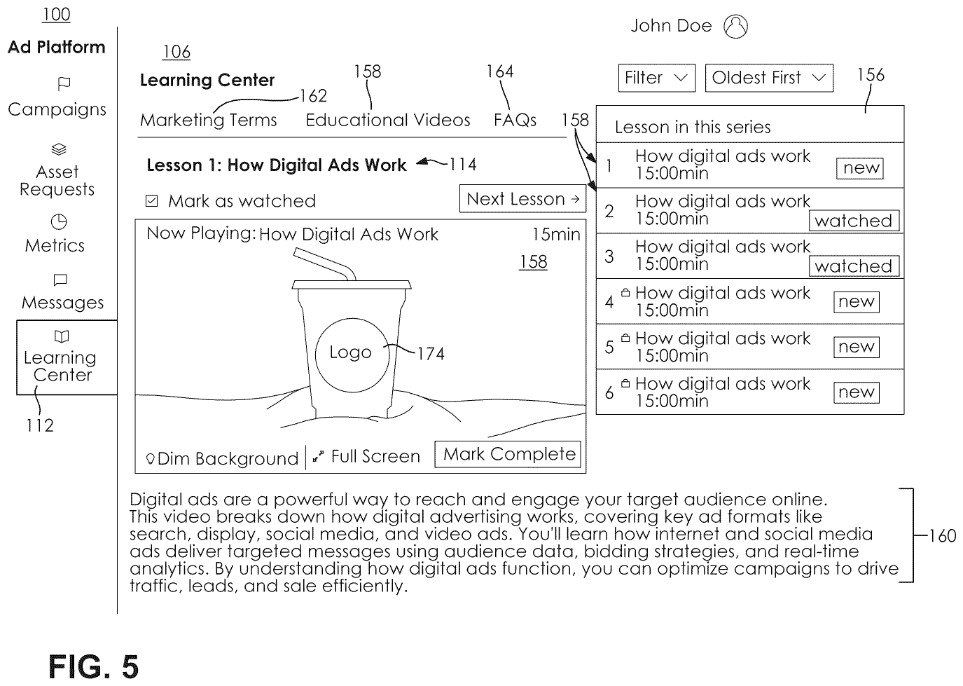

The marketing campaign 122 objective may be to convert a customer from seeing a banner 178, clicking through to a website advertisement 176, and making a purchase. Upon launching the marketing campaign 122, the AI module 132 may generate an analytics forecast 134 predicting that, with the campaign parameter 108 and target demographic 194 of the campaign 122 such as budget, flight dates, etc., the entrepreneur should receive 100-150 purchases within that campaign 122 flight. If the campaign 122 is not predicted to reach the desired target goal based on a KPI 200, the campaign module 118 may act to correct the marketing campaign 122 to place advertisements elsewhere or for a longer period. As the entrepreneur continues to use the system 100, the AI module 132 may learn the business through campaign 122 data, where more data collection enables the AI module 132 to become more accurate when generating analytics forecasts 134 and determining marketing corrections. The campaign 122 and analytics forecast 134 may be displayed in real time through the dashboard on the user interface module 106, as shown in FIGS. 5-8.

The campaign module 118 may directly tie this data to earned revenue of the entrepreneur from the marketing campaign 122 by utilizing a financial service 218 such as Quickbooks® accounting software to determine a real-time financial accounting 216. With the measurement of unique KPIs 200 and a campaign 122 specific financial accounting 216, the campaign module 118 may measure how the campaign 122 performs in correlation to the goals of the entrepreneur. Where the entrepreneur is brand-new to advertising strategies, the entrepreneur may utilize the financial accounting 216 in conjunction with an analytics forecast 134 from the AI module 132 as a replacement business plan for pitching to investors and seeking start-up capital. The campaign module 118 may provide a road map for the entrepreneur and investors to emulate a marketing strategy and budget needed to reach a goal of the entrepreneur. Using historical data, financial service 218, similar industry and markets, and look alike audiences, the system 100 may understand the pacing of the marketing campaign 122 and how it relates to the financial goals, i.e. 500 purchases per month avg., totaling 6,000 purchases per year. For instance, if two months into the annual campaign 122, the marketing campaign 122 is overperforming, the entrepreneur may inform investors by providing the financial accounting 216.

Alternatively, if the marketing campaign 122 is underperforming, even after campaign module 118 alters the campaign 122 based on calculations made by the analytics module 124 with specific KPIs 200, the entrepreneur and investor may use this information in early stages of investing to decide a plan of action, for example, increasing or aborting the investment. The entrepreneur may understand in real time whether or not the marketing campaign 122 may be likely to succeed, based on the real time data and analytics, e.g. the campaign 122 requires more capital to reach revenue goals for Q1, Q2, etc. For an investor, this data may be presented in real time to enable the investor to invest earlier, acting months prior to a significant loss.

### Example 2: ABC Corp. Needs to Sell 500 Running Shoes Per Month

ABC Corp. sets a sales goal of 1,000 running shoes per month using the system 100. As shown in FIG. 5, ABC may learn through the education module 112 through tutorials how to successfully create a target demographic 194, how to increase online impressions 202, clicks 204, and conversions 214 through effective messaging, strategic flight duration, budgeting, etc. ABC may then set a campaign parameter 108 within the system 100. During this process, the campaign module 118 may advise ABC regarding demographic preference 184, budget allocation 192, advertisement quantity 196 or advertisement duration 198 in order to successfully reach these goals. The analytics module 124 may effectively accomplish this through historical data, look-a-like audiences, similar industry/markets, 3^{rd} party information, and data collected from previous campaigns 122 that ABC has created.

As the campaign 122 reaches the intended audience, the system 100 may measure specific KPIs 200 as related to the goals set for ABC. For example, two weeks into a campaign 122, the system 100 may determine that the marketing campaign 122 is falling short of clicks 204 from the advertisement 176 for demographic group 188 men 18-29, but the campaign 122 has a high CTR 206 with demographic group 188 men 34-49. The analytics module 124 also determines that the campaign 122 is not getting enough impressions 202 or clicks 204 from demographic group 188 females 54-69 but has a great view through rate (VTR) with demographic group 188 females 25-34. The campaign module 118 may then recommend that ABC change the target of the display campaign 122 to stop delivering impressions 202 to men 18-29 and increase impressions 202 being delivered to men 34-49. The system 100 may also advise ABC to increase the advertisement quantity 196 targeting demographic group 188 females 25-34. The campaign module 118 may also allow ABC to reach the target demographic 194 through other creative material 180 such as soundbites provided to podcast producers to use during podcast episodes targeting similar audiences. With these changes, ABC may see that the campaign 122 delivers the digital asset 120 to the correct audience, resulting in an increase in running shoe sales.

In the fourth week, ABC sells 600 running shoes. The analytics module 124 may analyze the sales data through an integration with a financial service 218 such as FreshBooks® software program. The analytics module 124 may indicate that the campaign 122 is directly producing sales and is proceeding to surpass the goal of selling 1,500 running shoes in the third month of the campaign 122. ABC may then update the budget allocation 192, advertisement quantity 196, advertisement duration 198, etc., that is needed to continue to reach the goals of ABC. The investor may also see the positive trajectory of ABC and have real-time data to determine whether to increase or decrease any investment.

### Example 3: Start-Up Journey with First-Time Marketing

Consider the journey of a start-up, led by an owner who may require marketing expertise. The owner signs up for the system 100, choosing a membership level that suits the needs of the campaign 122. The owner interface module 106 of the system 100 is intuitive, allowing the owner to easily input an initial campaign parameter 108 and receive tailored instructional content 114. The instructional content 114 includes video content 158 and text-based content 160 on branding basics and digital marketing strategies, which the owner absorbs to better understand how to market the new start-up effectively. The owner launches a campaign 122 based on the knowledge received from the education module 112 and receives valuable insights from the integration of a financial service 218 that allows the owner to view the ROI in real-time. For example, the owner may focus the campaign 122 on a local target demographic 194, displaying a video 172 promoting the startup on downtown market kiosks, hotel lobbies, and sports bars.

As the campaign 122 progresses, the analytics module 124 begins to assess the campaign parameter 108 of the owner and the performance of the initial marketing efforts. The education module 112 may adjust the instructional content 114 it provides based on the interactions and learning feedback 116 of the owner, ensuring that the information remains relevant and practical for the specific needs of the owner. The dynamic learning environment of the education module 112 helps the owner improve marketing skills and apply them directly to the marketing campaign 122. With the knowledge gained from the instructional content 114, the owner decides to broaden the geographic reach of the campaign 122, displaying the video 172 in small business lobbies in neighboring towns.

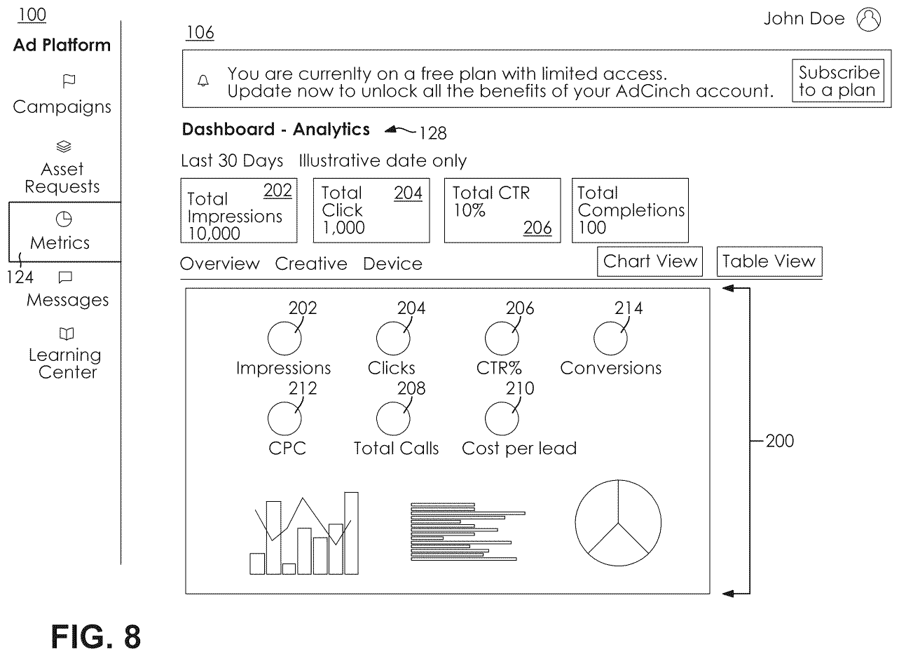

Throughout the campaign 122, the analytics module 124 may automatically suggest modifications based on real-time data, providing a campaign analysis 128 to the owner, as shown in FIG. 8. For instance, if the initial campaign 122 targeting a specific demographic group 188 isn't performing as expected, the analytics module 124 might suggest widening the target demographic 194 or adjusting the campaign 122 budget allocation 192, advertisement quantity 196, or advertisement duration 198. For example, displaying the video 172 at surrounding college campus sports games, broadening the demographic preference 184 of the campaign 122 to include younger age groups. These suggestions may be based on data-driven insights, significantly enhancing the ability of the owner to make informed marketing decisions and improve the market reach and profitability of the business. Based on these analytics, the campaign module 118 may direct the owner to review additional instructional content 114 in order to make an informed decision on campaign 122 alterations.

### Example 4: Digital Marketing for a New Fashion Brand

A designer, engaged in launching a new fashion brand, may initiate a digital marketing journey by accessing the system 100. Through the user interface module 106, the designer may input their initial campaign parameter 108, including data on a target demographic 194 such as age, gender, and location, alongside budget allocation 192 constraints and marketing objectives. The designer may also provide an earning feedback 116 regarding the designer's current understanding of marketing strategies, assisting the education module 112 in tailoring the instructional content 114. The education module 112 may then deliver instructional content 114 focused on branding strategies and audience engagement techniques to the designer, ensuring that the materials are aligned with the learning progress and provided learning feedback 116 of the designer.

The campaign module 118 may utilize the received campaign parameter 108 to generate a personalized marketing campaign 122 from several digital assets 120 that the designer uploads to the user interface module 106. The digital assets 120 include a logo 174 and a video 172. The designer now needs a banner 178 and other creative material 180 such as social media content and post. To accommodate the needs of the campaign 122, the AI module 132 generates a banner 178 and a social media post complete with website links and a catchy tagline. The analytics module 124 may utilize an advertisement metric 126 to assess the efficacy of the campaign 122 and the online traction of each digital asset 120, producing a comprehensive campaign analysis 128. The campaign analysis 128 may guide the generation of a real-time performance report 130 by the analytics module 124, which may then be reviewed to determine necessary adjustments. If the real-time performance report 130 indicates a need for optimization, the campaign module 118 may modify advertising strategies such as budget allocation 192 towards better-performing demographic group 188 or adjusting the frequency of the advertisement 176.

The designer may continue to refine their marketing efforts by interacting with the AI module 132 for, adapting strategies based on an analytics forecast 134, predicting dynamic market conditions and business growth in the industry. The combination of the analytics forecast 134 from the AI module 132 and the ability of the analytics module 124 to correlate direct advertising outcomes with financial projections through a financial service 218 serves as a valuable asset for aligning investment decisions with marketing performance. This holistic approach may facilitate both short-term and long-term decision making to optimize the ROI for the campaign 122.

As the campaign 122 progresses, the analytics module 124 may continuously evaluate performance data such as impressions 202, clicks 204, total calls 208, or conversions 214 to ensure alignment with the evolving goals of the designer. The adaptive nature of the analytics module 124 and real-time capabilities of the AI module 132 may provide the designer with a responsive and comprehensive solution to any shortcomings, supporting ongoing engagement and success in their digital marketing endeavors. For example, if the analytics module 124 determines that the campaign 122 is not reaching a demographic group 188 of urban night-club goers, the AI module 132 may generate a video 172 depicting the most popular piece of clothing sold by the designer, allowing the system 100 to post the video 172 to a social media site for increased online engagement. By incorporating the additional digital assets 120 in the campaign 122 in a timely fashion, the analytics module 124 and AI module 132 may, in combination, transform an underperforming campaign 122 into a success, allowing the most popular clothing pieces of the designer to go viral and hit record sales.

### Example 5: Launching an Eco-Friendly Consumer Product

A philanthropist focusing on eco-friendly consumer products may utilize the system 100 to strategize and manage an advertising campaign 122 for a new tote bag made of 100% repurposed material. By entering a campaign parameter 108 into the user interface module 106, the philanthropist may define their target demographic 194, which includes environmentally conscious individuals within specific geographic areas. Budget allocation 192 considerations and marketing goals may also be specified, with the analytics module 124 utilizing these inputs to tailor the instructional content 114 through the education module 112. Interactive video content 158 in the form of tutorials may assist the philanthropist in understanding how to craft messages that resonate with their eco-friendly audience, providing foundational knowledge necessary for effective marketing endeavors.

The campaign module 118 may process the campaign parameter 108 to formulate a marketing campaign 122 aimed at maximizing audience engagement and conversions 214. The analytics module 124 may analyze the performance of the campaign 122 by using an advertisement metric 126, resulting in a detailed campaign analysis 128. By generating a real-time performance report 130 that captures these insights, the analytics module 124 may inform the philanthropist of current successes and areas for improvement. Should the advertisement metric 126 indicate inefficiencies, the campaign module 118 may implement modifications, such as shifting resources towards higher-performing channels or altering messaging strategies.

With the campaign 122 adjustments in place, the analytics module 124 may prompt the philanthropist to engage with further instructional content 114 to deepen their understanding of effective advertising techniques and strategies, such as providing audiences with educational material on repurposed materials. The philanthropist may be encouraged to offer additional learning feedback 116, enabling the education module 112 to refine educational offerings in response to the developing expertise of the designer. A demographic report 190 provided by the analytics module 124 may enhance this learning process, offering guidance on how to adapt campaigns 122 to achieve optimal performance within segmented audience groups. The analytics module 124 may allow the philanthropist to spot trends in the number of sales on flight dates when a digital asset 120 is used that includes details on the raw materials used to create the tote bag compared to when a digital asset 120 is used that does not include such details. This analysis may encourage the philanthropist to adjust raw material purchasing to include fair-trade sources, adding these details to the digital asset 120 used. The philanthropist may also adjust the volume of the tote bag inventory based on analysis of sales during certain flight dates, and may adjust the location of items being sold depending on geographic success of the campaign 122.

As the philanthropist gains proficiency and confidence in managing their campaign 122 for their eco-friendly tote bag, the analytics module 124 may suggest that the philanthropist utilize a team feature 171 of the system 100 to allow the philanthropist and nonprofits with eco-conscious endeavors to collaborate on the campaign 122, increasing the target demographic 194 reach and allowing the philanthropist to pledge a percentage of the sales profits from the eco-friendly tote bag to the nonprofits for a worthy cause. This strategic alignment may foster sustainable growth and establish the brand recognition of the philanthropist as a trustworthy presence within the eco-conscious consumer landscape.

### Example 6: Expanding Services of a Fitness Training Center

A managing trainer at a fitness training center is aiming to expand clientele and utilizes the system 100 to provide a structured approach to outreach efforts. The trainer may begin by supplying a campaign parameter 108 related to fitness service offerings, target demographics 194 such as age and fitness goals, and budget allocation 192 through the user interface module 106. The education module 112 may utilize this information to curtail instructional content 114 that explores effective ways to communicate the benefits of the training center's services and engage potential clients. The interactive video content 158 in the form of tutorials and quizzes 166 may further support the trainer in applying theoretical marketing knowledge practically.

Using the specified campaign parameter 108, the campaign module 118 may devise a custom marketing campaign 122 designed to attract and retain fitness enthusiasts within the geographic area of the fitness training center. By processing an advertisement metric 126 collected during the execution of the campaign 122, the analytics module 124 may produce a comprehensive campaign analysis 128. A real-time performance report 130 may be generated, indicating trends in potential client engagement, conversions 214, and areas requiring adjustment. With insights from the real-time performance report 130, the campaign module 118 may execute strategies to enhance visibility and impact, such as adjusting the demographic preference 184 and advertisement preference 186 of the campaign 122 based on search engine analytics, e.g. local search trends for fitness equipment or exercise routines. The campaign module 118 may also adjust the advertisement preference 186 of the campaign 122, adding other creative material 180 such as banners 178 and videos 172 for displaying on digital billboards on the side of local highways.

As the analytics module 124 adjusts aspects of the campaign 122, the trainer is met with an increase in new clientele signing up for fitness memberships and classes at the fitness training center. The trainer inquires how the new clientele heard about the center, and each new client responds with various answers including, “I saw your fitness center on Google® search engine when I searched for fitness ideas in the local area”, “I saw your post on social media showing your fitness classes for beginners”, and “I was driving along the highway and saw your fitness center ad on the a billboard”. Receiving positive feedback on the performance of the campaign 122, the trainer decides to increase the advertisement quantity 196 and advertisement duration 198 of the campaign 122, leading to several months of increase clientele and a full roster for each fitness class offered at the fitness training center.

Engaging with the system 100 may allow the fitness training center to adapt online marketing strategies to maintain relevance and competitiveness in a dynamic industry. The interactive and nonlinear architecture of the system 100 ensures that the trainer may continuously develop marketing expertise while simultaneously optimizing campaign 122 management to align with their overarching business objectives. Through the provision of real-time analytics and tailored instructional content 114, the system 100 may foster robust growth and long-term success within the fitness industry, providing targeted impressions 202 and brand recognition in both online search and social media spaces.

Example embodiments are provided so that this disclosure will be thorough and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms, and that neither should be construed to limit the scope of the disclosure. In some example embodiments, well-known processes, well-known device structures, and well-known technologies are not described in detail. Equivalent changes, modifications and variations of some embodiments, materials, compositions and methods can be made within the scope of the present technology, with substantially similar results.

What is claimed is:

1. A system for digital marketing analysis and management for a user, comprising:
a processor;
a memory in communication with the processor, the memory including a user interface module, an education module, a campaign module, and an analytics module;
wherein:
the user interface module is configured to:
receive a campaign parameter and a learning feedback from the user;
the education module is configured to:
provide an instructional content to the user based on campaign parameter, and
adjust the instructional content based on the learning feedback;
the campaign module is configured to:
receive the campaign parameter from the user interface module, and
generate a campaign for the user based on the campaign parameter;
the analytics module configured to:
analyze the campaign based on an advertisement metric to produce a campaign analysis, and
generate a real-time performance report based on the campaign analysis of the campaign; and
the campaign module is further configured to:
receive the real-time performance report from the analytics module,
adjust the campaign when the real-time performance report includes a determination for adjustment, and
direct the user to view the instructional content and to provide another learning feedback when the real-time performance report includes a determination that adjusting the campaign requires an understanding of the user.

2. The system of claim 1, wherein the campaign module is further configured to generate a digital asset for the user.

3. The system of claim 2, wherein the memory further includes a database configured to store the campaign parameter, the learning feedback, the instructional content, the campaign, the real-time performance report, the another learning feedback, and the digital asset.

4. The system of claim 1, wherein the memory further includes an artificial intelligence (AI) module configured to:
receive the real-time performance report from the analytics module, and
generate an analytics forecast based on the real-time performance report.

5. The system of claim 4, wherein the analytics module is further configured to segment the real-time performance report by a demographic group to produce a demographic report, and adjust the analytics forecast based on the demographic report.

6. The system of claim 4, wherein the memory further includes a reporting module configured to present the real-time performance report and the analytics forecast to the user via the user interface module.

7. The system of claim 1, wherein the analytics module is further configured to include in the real-time performance report a financial accounting of the user based on the campaign.

8. The system of claim 1, wherein adjusting the campaign may include a member selected from a group consisting of a budget allocation, a target demographic, an increase in advertisement quantity, an increase in advertisement duration, and combinations thereof.

9. The system of claim 1, wherein the instructional content includes a video content to assess an understanding of the user.

10. A method for digital marketing analysis and management for a user, comprising:
providing a processor, a memory in communication with the processor, the memory including a user interface module, an education module, a campaign module, and an analytics module,
wherein:
the user interface module is configured to:
receive a campaign parameter and a learning feedback from the user,
the education module is configured to:
provide an instructional content to the user based on campaign parameter, and
adjust the instructional content based on the learning feedback,
the campaign module is configured to:
receive the campaign parameter from the user interface module, and
generate a campaign for the user based on the campaign parameter;
the analytics module configured to:
analyze the campaign based on an advertisement metric to produce a campaign analysis, and
generate a real-time performance report based on the campaign analysis of the campaign, and
the campaign module is further configured to:
receive the real-time performance report from the analytics module,
adjust the campaign when the real-time performance report includes a determination for adjustment, and
direct the user to view the instructional content and to provide another learning feedback when the real-time performance report includes a determination that adjusting the campaign requires an understanding of the user;
receiving the campaign parameter and the learning feedback from the user via the user interface module;
providing an instructional content to the user based on campaign parameter via the education module;
adjusting the instructional content based on the learning feedback via the education module;
generating a campaign via the campaign module for the user based on the campaign parameter;
analyzing the campaign via the analytics module based on an advertisement metric to produce a campaign analysis;
generating a real-time performance report via the analytics module based on the campaign analysis of the campaign;
adjusting the campaign via the campaign module when the real-time performance report includes a determination for adjustment; and
directing the user to view the instructional content and to provide another learning feedback when the real-time performance report includes a determination that adjusting the campaign requires an understanding of the user.

11. The method of claim 10, wherein:
the campaign module is further configured to generate a digital asset for the user; and
the method further comprising:
generating a digital asset for the user via the campaign module.

12. The method of claim 11, wherein:
the memory further includes a database configured to store the campaign parameter, the learning feedback, the instructional content, the campaign, the real-time performance report, the another learning feedback, and the digital asset; and
the method further comprising:
storing the campaign parameter, the learning feedback, the instructional content, the campaign, the real-time performance report, the another learning feedback, and the digital asset in the database.

13. The method of claim 10, wherein:
the memory further includes an artificial intelligence (AI) module configured to receive the real-time performance report from the analytics module, and generate an analytics forecast based on the real-time performance report; and
the method further comprising:
receiving the real-time performance report via the AI module from the analytics module; and
generating the analytics forecast via the AI module based on the real-time performance report.

14. The method of claim 13, wherein:
the memory further includes a reporting module configured to present the real-time performance report and the analytics forecast to the user via the user interface module; and
the method further comprising:
presenting the real-time performance report by the reporting module to the user via the user interface module; and
presenting the analytics forecast by the reporting module to the user via the user interface module.

15. The method of claim 13, wherein:
the analytics module is further configured to segment the real-time performance report by a demographic group to produce a demographic report, and adjust the analytics forecast based on the demographic report; and
the method further comprising:
segmenting the real-time performance report via the analytics module by a demographic group to produce a demographic report; and
adjusting the analytics forecast via the analytics module based on the demographic report.

16. The method of claim 13, wherein:
the analytics module is further configured to adjust a budget allocation based on the analytics forecast; and
the method further comprising:
adjusting a budget allocation based on the analytics forecast.

17. The method of claim 10, wherein:
the analytics module is further configured to include in the real-time performance report a financial accounting of the user based on the campaign; and
the method further comprising:
generating a real-time performance report that includes a financial accounting of the user based on the campaign.

18. The method of claim 10, wherein the step of adjusting the campaign via the campaign module is automated based on a key performance indicator.

19. The method of claim 10, wherein:
the campaign module includes a team feature configured to allow a plurality of users to collaborate on a campaign; and
the method further comprising:
allowing a plurality of users to collaborate on a campaign via the campaign module.

20. A non-transitory computer-readable medium storing processor instructions for digital marketing analysis and management for a user that, when executed by a processor, cause the processor to:
receive a campaign parameter and a learning feedback from the user;
provide an instructional content to the user based on campaign parameter;
adjust the instructional content based on the learning feedback;
generate a campaign for the user based on the campaign parameter;
analyze the campaign based on an advertisement metric to produce a campaign analysis;
generate a real-time performance report based on the campaign analysis of the campaign;
adjust the campaign when the real-time performance report includes a determination for adjustment; and
direct the user to view the instructional content and to provide another learning feedback when the real-time performance report includes a determination that adjusting the campaign requires an understanding of the user.
